(19) United States
(12) Patent Application Publication
(10) Pub. No.: US 2025/0372929 A1
(43) Pub. Date: Dec. 4, 2025

(54) POWER BASE

(71) Applicant: Timothy John Bleidistel, Long Beach, CA (US)

(72) Inventor: Timothy John Bleidistel, Long Beach, CA (US)

(21) Appl. No.: 18/677,835

(22) Filed: May 29, 2024

(51) Int. Cl. H01R 25/00; A47G 33/12; H01R 13/713; H01R 13/74; H01R 105/00

(52) U.S. Cl. CPC H01R 25/006; A47G 33/12; H01R 13/7135; H01R 13/748; A47G 2033/122; H01R 2105/00

(57) ABSTRACT

The invention relates generally to stands or bases, such as for decorative trees (e.g., Christmas trees), and more specifically, to stands or bases with one or more electrical receptacle assemblies for streamlining the electrical power cables that are utilized in powering devices (such as multiple string lights) used on the tree that is supported on the stand or base. The electrical receptacle assembly includes a housing, a face plate, and a front surface portion defining a plurality of openings and electrical wiring. The base assembly of the present invention may be of different shapes and sizes, and may include any number of electrical receptacle assemblies.

### FIELD OF INVENTION

The invention relates generally to stands or bases, such as for decorative trees (e.g., Christmas tree), and more specifically, to stands or bases with one or more power outlets for streamlining the electrical power cables that are utilized in powering devices (such as string lights) on the stand or base.

### BACKGROUND

A multitude of stands of varying configurations exist for decorative trees (such as holiday or Christmas trees) and other decorations. Oftentimes, these decorations include use of lighting such as incandescent lights, string lights, and tree toppers, including use of other ornamentation such as an electric train set around the stand or tree. These decorations involve usage of one or more power cords, each of which must be connected to an outlet or several outlets. In such usage, power cords must often be extended across pathways normally used for walking, and are difficult to conceal. The maze of power cords strung along the floor from the stand is unsafe, presents trip hazards, and is unsightly, and distracting. Thus, there exists a need to streamline the connection of cords to address or overcome these deficiencies or issues.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

In one aspect of the present invention, a power base of the present invention includes a base assembly configured to abut a floor surface, wherein the assembly is circular in shape and comprises a top section, an upper section, a side wall, and in some embodiments, a bottom cover that abuts the floor. The base assembly includes a slot or holder in the top section where a tree (such as an artificial Christmas tree) is set or fitted.

The base assembly includes one or more electrical receptacle assemblies adapted to receive one or more plugs, such as plugs for tree lights. The electrical receptacle assembly includes a housing, a face plate, and a front surface portion defining a plurality of openings and electrical wiring. The electrical wiring may be connected to another electrical receptacle assembly, and is connected to a main cord with a plug that connects to a power source. The housing includes one or more holes through which the electrical wiring associated with one or more other receptacle assemblies passes through.

The electrical cable or main cord includes a male plug which is adapted to be electrically connected to a source of AC electric power. An aspect of the present invention may also include a ground fault circuit interrupter (GFCI) which is a safety device that protects people from electrical shock by shutting off power in the event of a ground-fault.

The base assembly of the present invention may be of different shapes and sizes, such as but not limited to, polygonal or angular, cuboid, and a truncated pyramid.

The base assembly also may include any number of electrical receptacle assemblies.

The base assembly may also include a power cord that is retractable.

These and other aspects, embodiments, features, and advantages of the invention will become better understood with regard to the following description, appended claims and accompanying drawings.

Certain features and advantages of the present invention have been generally described in this summary section. However, additional features, advantages and embodiments are presented herein or will be apparent to one of ordinary skill of the art in view of the drawings, specification and claims hereof. Accordingly, it should be understood that the scope of the invention shall not be limited by the particular embodiments disclosed in this summary section.

### BRIEF DESCRIPTION OF THE DRAWINGS

The foregoing aspects and the attendant advantages of the present invention will become more readily appreciated by reference to the following detailed description, when taken in conjunction with the accompanying drawings, wherein:

FIG. 1 is a perspective view of an embodiment of the power base, with a pole or a trunk of a decorative item (such as an artificial tree with lights) fitted within an opening within the base, and showing plugs from the item or other decorations;

FIG. 2 is a perspective view of an embodiment of the power base;

FIG. 3 is a side elevation view of an embodiment of the power base;

FIG. 4 is a side elevation view of an embodiment of the power base, showing a hole through which a power cord passes through;

FIG. 5 is a side elevation view of an embodiment of the power base, showing a portion of the power cord extending from the base;

FIG. 6 is a side elevation view of an embodiment of the power base, showing a portion of the power cord extending from the base;

FIG. 7 is a top view of an embodiment of the power base, showing a portion of the power cord extending from the base;

FIG. 8 is a bottom view of an embodiment of the power base;

FIG. 9 is a cross-sectional view of an embodiment of the power base, showing a plug connected to an electrical assembly of the power base;

FIG. 10 is a top view of another embodiment of the power base having two electrical receptacle assemblies;

FIG. 11 is a top view of another embodiment of the power base having one electrical receptacle assembly;

FIG. 12 is a top view of another embodiment of the power base having an angular shape; and,

FIG. 13 is top view of another embodiment of the power base having a pyramidal shape.

Reference symbols or names are used in the figures to indicate certain components, aspects or features shown therein. Reference symbols common to more than one figure indicate like components, aspects or features shown therein.

### DETAILED DESCRIPTION

The subject matter of aspects of embodiments of the present invention is described with specificity herein to meet statutory requirements. However, the description itself is not intended to limit the scope of any patent issuing from this description. Rather, the inventor has contemplated that the claimed subject matter might also be embodied in other ways, to include different elements or combinations of elements similar to the ones described in this document, in conjunction with other present or future technologies.

Embodiments of the present invention relate generally to stands or bases, such as for decorative trees, and more specifically, to stands or bases with one or more power outlets for streamlining the electrical power cables that are utilized in powering devices or other decorative elements used in conjunction with the Christmas tree on the stand or base, such as multiple string lights and tree topper and other décor.

The device described herein includes a mechanism for supporting tree decors such as artificial Christmas trees, and consolidating or streamlining the electrical configuration used to power up various décor used on the tree, such as string lights. One skilled in the art will recognize, however, that the invention is not so limited. The device can also be used, for example but without limitation, to support living trees and other ornamental objects. The device can also be used to support many objects that require support in a substantially vertical manner such as, for example, ornamental trees, and flag poles.

The materials described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention, for example. Any dimensions or proportions appearing in the various drawings are for illustrative purposes only and are not intended to be limiting. Other dimensions and proportions are contemplated and intended to be included within the scope of the invention.

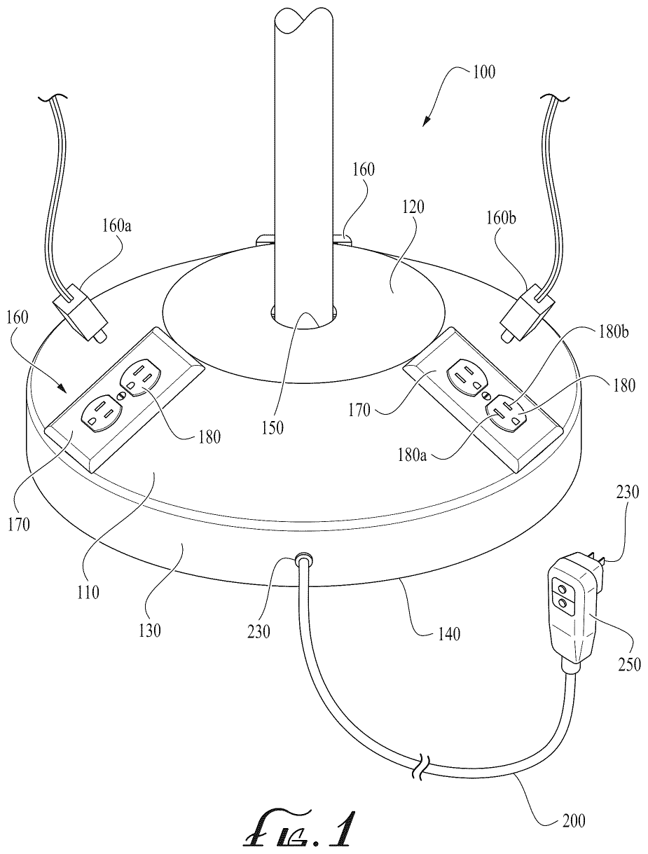

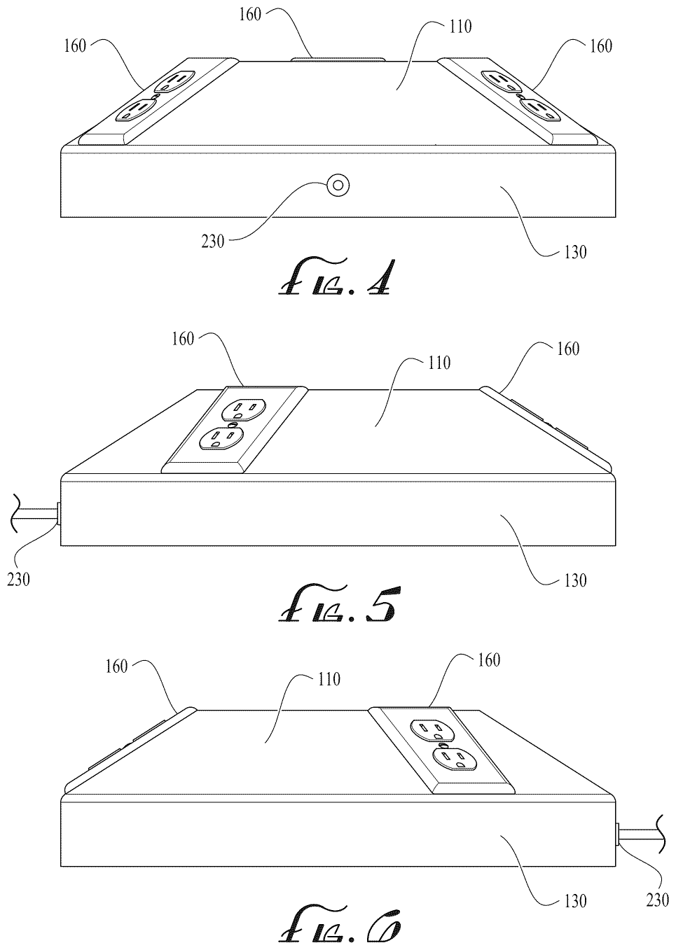

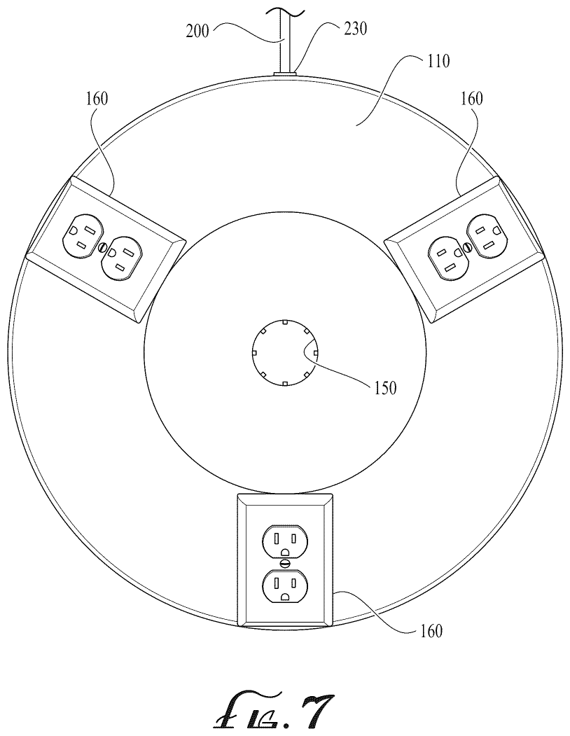

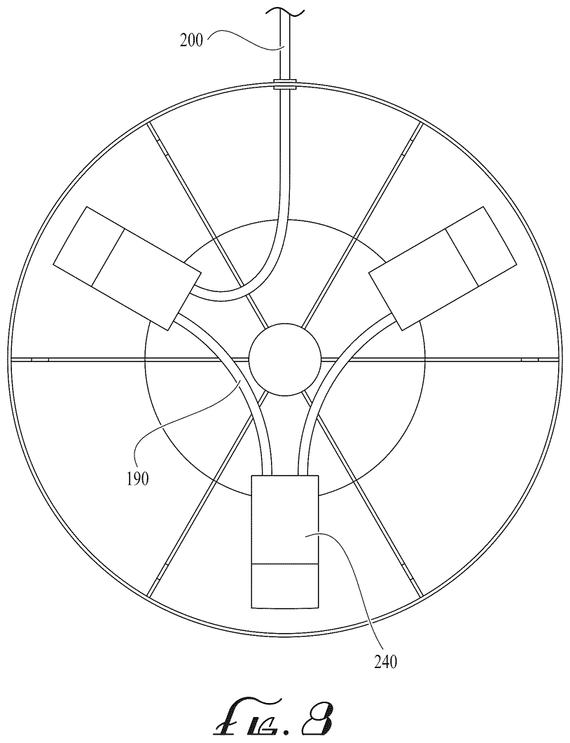

Referring to FIG. 1 through 7, an embodiment of the power base 100 depicted herein is circular in shape and comprises a top section 110, an upper section 120, a side wall 130, and a bottom edge 140 that abuts the floor. In some embodiments, the bottom may be covered. The base 100 includes a slot or holder 150 within the upper section 120 designed to securely fit a decorative tree, or other decor structure with a cylindrical body that needs to be supported in a substantially vertical manner.

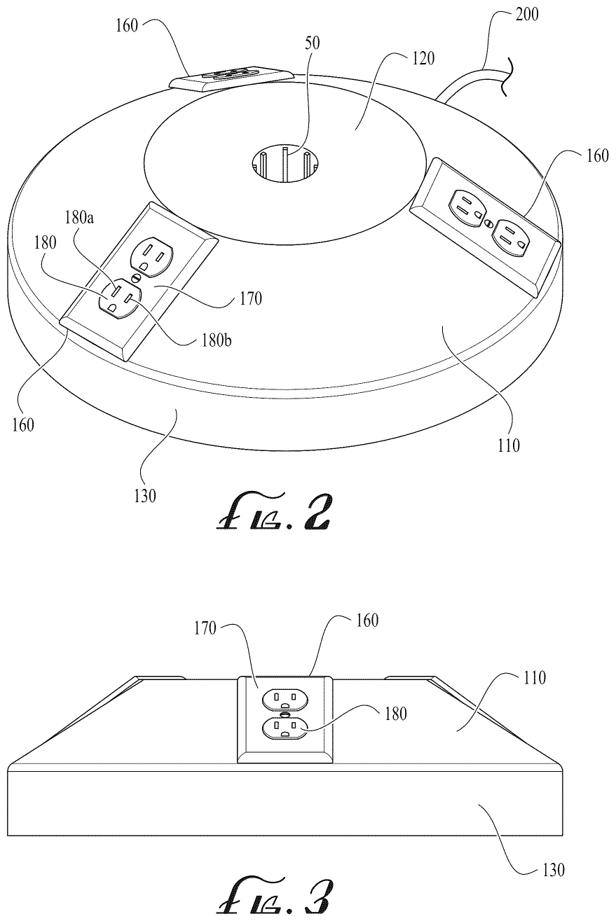

The slot or holder may have set screws to lock and securely fit a decorative tree, and in some instances, may have ribs 50, such as shown in FIG. 2, disposed vertically within the slot or holder to facilitate secure placement of the tree or like structure within the slot or holder. Other known retention mechanisms may be used, and the base can further comprise a locking mechanism for locking the tree within the stand. The base can further comprise an adapter for receiving one or more inserts. The inserts can comprise a consistent outer diameter, for insertion into the adapter, and a variety of inner diameters for use with a variety of tree diameters. The insert can be installed on the trunk of a tree and then installed into the adapter on the base simplifying the tree erection process.

Any one of a variety of suitable materials may be used to fabricate the power base, or its sections and/or walls, such as, but not limited to, plastic, resin, rubber, PVC, metal, composite materials, etc.

Referring to FIGS. 1 to 3, the base includes one or more electrical receptacle assemblies 160, such as on the top section 110. These assemblies are adapted to receive one or more plugs (160a and 160b), such as plugs for string lights used on the decorative tree that is being held by the stand. These assemblies are attached or affixed securely to the top section 110 such as by screws, or adhesives. The top section 110 has one or more openings configured to fit the one or more electrical receptacle assemblies.

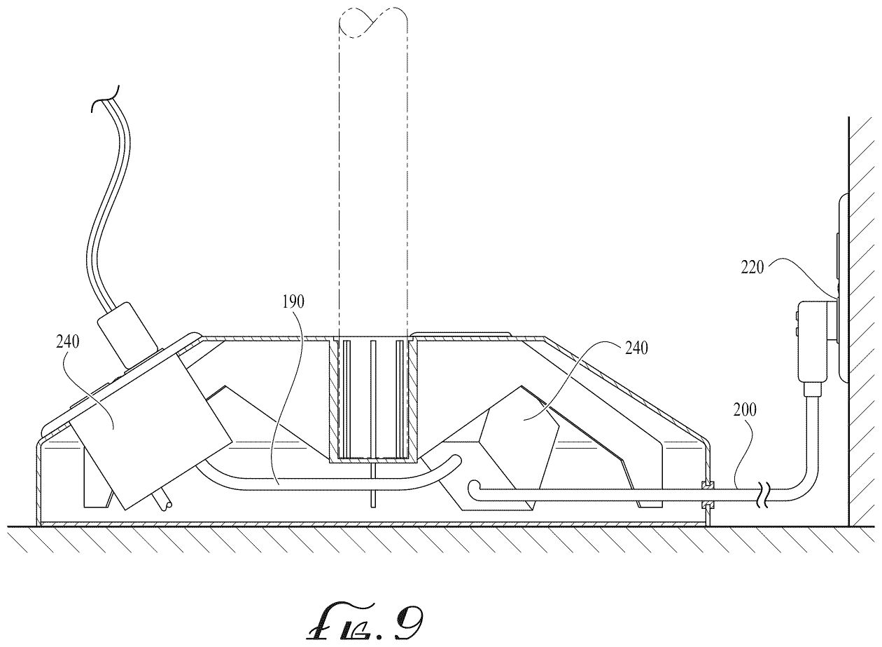

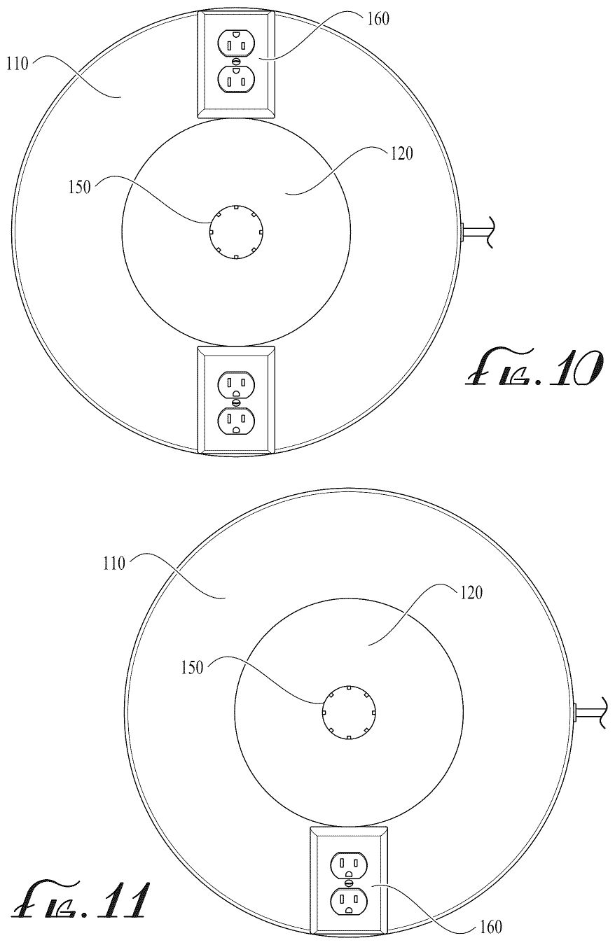

The electrical receptacle assembly 160 includes a housing 240 (FIG. 8), a face plate 170, and a front surface portion 180 defining a plurality of openings 180a and 180b, and electrical wiring 190 (FIG. 8). The electrical wiring 190 may be connected to another electrical receptacle assembly, and is connected to a main cord 200 with a plug 210 that connects to a power source 220 (FIG. 9). The side wall 130 includes at least an aperture or hole 230 through which the main cord 200 associated with one or more other receptacle assemblies passes through.

Referring to FIGS. 1 and 9, the electrical cable or main cord 200 includes a male plug 230 which is adapted to be electrically connected to a source of AC electric power 220 (FIG. 9).

The electrical receptacle assembly 160 used in one or more embodiments includes any receptacle that provides an AC (alternating current) or DC (direct current) voltage and includes AC electric power receptacles that provide 110-115 VAC, DC voltage receptacles or ports. A housing 240 defines a cavity for receiving the receptacle body, and a face plate 170 is coupled to the housing and defines a receptacle opening for engaging and supporting the electrical receptacle assembly. The face plate may take on many different sizes and shapes for a desired application, while the other components of the electrical receptacle assembly can remain the same.

Referring to FIGS. 1 and 9, an aspect of the present invention may also include a ground fault circuit interrupter (GFCI) 250 connected to the main cord 200. The GFCI is a safety device that protects people from electrical shock by shutting off power in the event of a ground-fault. Resettable circuit interrupting devices, such as GFCI devices, that include reverse wiring protection, and optionally an independent trip portions and/or a reset lockout portion may be used. The reverse wiring protection of such devices operates at both the line and load sides of the device so that in the event line side wiring to the device is improperly connected to the load side, fault protection for the device remains. The trip portion operates independently of a circuit interrupting portion used to break the electrical continuity in one or more conductive paths in the device. The reset lockout portion prevents the reestablishing of electrical continuity in open conductive paths if the circuit interrupting portion is non-operational or if an open neutral condition exists. A test button is used to test the trip mechanism and circuitry used to sense faults, and a reset button is used to reset the electrical connection between line and load sides. use an electrically activated trip mechanism to mechanically break an electrical connection between the line side and the load side. Such devices are resettable after they are tripped by, for example, the detection of a ground fault.

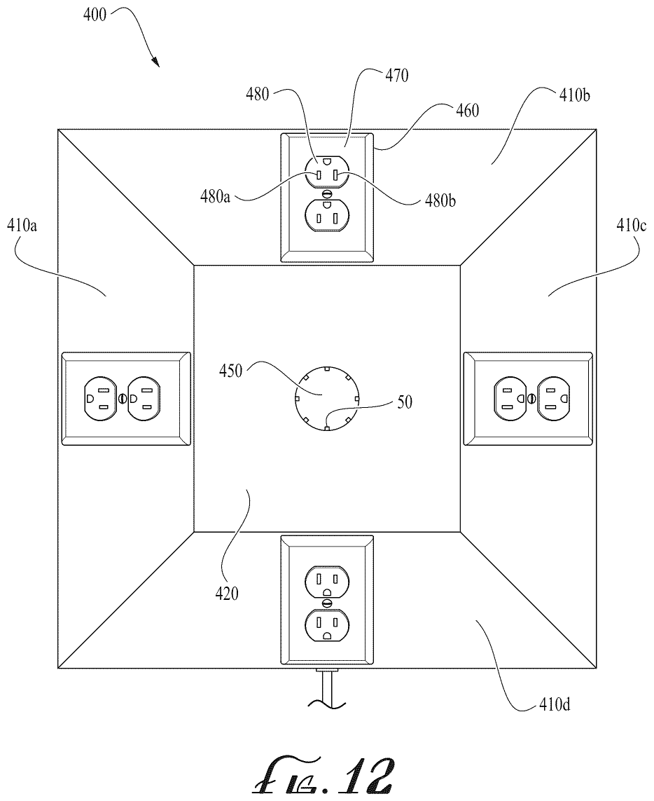

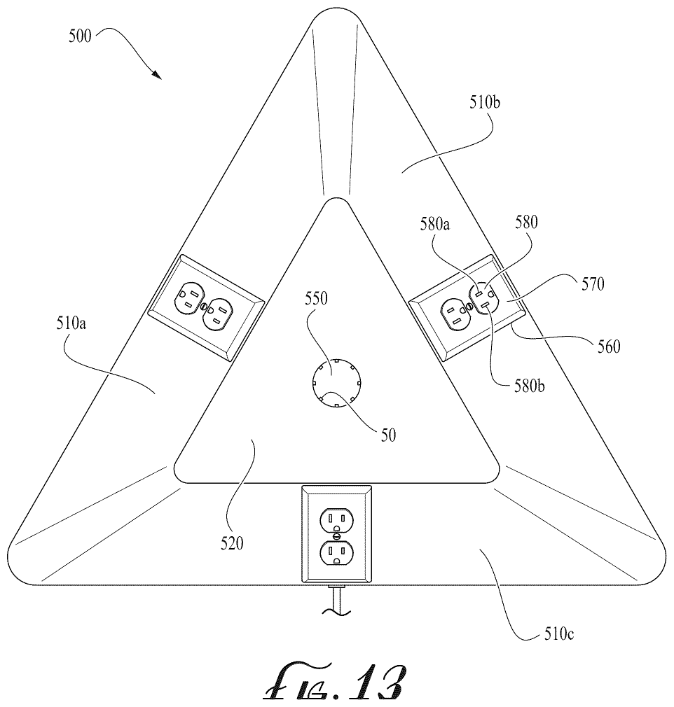

Other embodiments of the power base may include any number of electrical receptacle assemblies, such as shown in FIGS. 10 and 11. They may be of different shapes and sizes, such as but not limited to, polygonal or angular, cuboid, such as shown in FIG. 12, or a truncated pyramid, such as shown in FIG. 13.

Referring to FIG. 12, another embodiment of the power base 400 is of cube or cuboid shape which comprises a first top section 410a, a second top section 410b, a third top section 410c and a fourth top section 410d. This cuboid embodiment has an upper section 420 that has a slot or holder 450 within the upper section that is designed to securely fit a decorative tree (or other decor structure with a cylindrical body that needs to be supported in a substantially vertical manner). The slot or holder may have set screws to lock and securely fit a decorative tree, and in some instances, may have ribs 50, such as shown in FIG. 12, disposed within the slot or holder to facilitate secure placement of the structure within the slot or holder.

As shown in FIG. 12, the cuboid embodiment of the base includes one or more electrical receptacle assemblies 460. The electrical receptacle assembly 460 includes a face plate 470, and a front surface portion 480 defining a plurality of openings 480a and 480b adapted to receive one or more plugs, such as plugs to provide power to string lights used on the decorative tree that is being held by the stand.

Referring to FIG. 13, another embodiment of the power base 500 is of a truncated pyramid shape which comprises a first top section 510a, a second top section 510b, and a third top section 510c. This pyramidal embodiment has an upper section 520 that has a slot or holder 550 within the upper section that is designed to securely fit a decorative tree (or other decor structure with a cylindrical body that needs to be supported in a substantially vertical manner). The slot or holder may have set screws to lock and securely fit a decorative tree, and in some instances, may have ribs 50, such as shown in FIG. 13, disposed within the slot or holder to facilitate secure placement of the structure within the slot or holder.

As shown in FIG. 13, the pyramidal embodiment of the base includes one or more electrical receptacle assemblies 560. The electrical receptacle assembly 560 includes a face plate 570, and a front surface portion 580 defining a plurality of openings 580a and 580b adapted to receive one or more plugs, such as plugs to provide power to string lights used on the decorative tree that is being held by the stand.

The sections forming the body of the various embodiments of the power base may be fused or molded into a unitary structure or injection molded, and are of sufficient thickness to provide support or stability to the object held within the base.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications so as to thereby enable others skilled in the art to best utilize the invention and various embodiments with various modifications as are suited to the particular use contemplated.

Although specific embodiments of the invention have been described, various modifications, alterations, alternative constructions, and equivalents are also encompassed within the scope of the invention.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A power base, comprising:
a top section;
an upper section;
a side wall;
a slot within the upper section configured to support a structure in a substantially vertical manner;
an electrical receptacle assembly on the top section;
wherein the electrical receptacle assembly comprises a housing, a face plate, and a front surface portion defining a plurality of openings, and electrical wiring, and wherein the electrical receptacle assembly is adapted to receive one or more plugs;
a main cord connected to the electrical receptacle assembly, and which is adapted to connect to a power source.

2. The power base of claim 1, further comprising a ground fault circuit interrupter connected to the main cord.

3. The power base of claim 1, wherein the slot has ribs disposed vertically within the slot to facilitate secure placement of the structure within the slot.

4. The power base of claim 1, wherein the main cord is retractable.

5. The power base of claim 1, wherein the base has a polygonal shape.

6. The power base of claim 1, wherein the base has a circular shape.

7. The power base of claim 1, wherein the base comprises a second receptacle assembly on the top section.

8. The power base of claim 6, wherein the base comprises a third receptacle assembly on the top section.

9. The power base of claim 7, wherein the base comprises a fourth receptacle assembly on the top section.

10. A base, comprising:
a stand for mounting decorative objects in a substantially vertical manner;
at least one electrical receptacle assembly disposed on the stand;
a cord connected to the electrical receptacle assembly; and,
a ground fault circuit interrupter connected to the cord and which is adapted to connect to a power source.

11. The base of claim 10, wherein the electrical receptacle assembly comprises a housing, a face plate, and a front surface portion defining a plurality of openings, and electrical wiring, and wherein the electrical receptacle assembly is adapted to receive one or more plugs.

12. The base of claim 11 wherein the electrical wiring connects to one or more electrical assemblies.

13. The base of claim 10, wherein the base has a polygonal shape.

14. The power base of claim 10, wherein the base has a circular shape.

15. A power base assembly, comprising:
a first top section;
a second top section;
a third top section;
an upper section;
wherein the upper section has a slot designed to securely fit a cylindrical structure;
an electrical receptacle assembly within the first top section; and,
wherein the electrical receptacle assembly comprises a housing, a face plate, and a front surface portion defining a plurality of openings, and electrical wiring, and wherein the electrical receptacle assembly is adapted to receive one or more plugs.

16. The base of claim 15, further comprising a ground fault circuit interrupter which is adapted to connect to a power source.

17. The base of claim 15, wherein the base comprises a second receptacle assembly on the second top section.

18. The base of claim 17, wherein the base comprises a third receptacle assembly on the third top section.

19. The base of claim 18, wherein the base comprises a fourth electrical receptacle assembly.

20. The base of claim 19, wherein the electrical receptacle assemblies are connected by electrical wiring connected to a main cord which is adapted to connect to a power source.
